(19) United States
(12) Patent Application Publication
(10) Pub. No.: US 2026/0336985 A1
(43) Pub. Date: Oct. 29, 2026

(54) ENGINE FRONT LIFT BRACKET

(71) Applicant: FCA US LLC, Auburn Hills, MI (US)

(72) Inventors: Mahammad Akbar Basha, Chennai (IN); Arnold-Angelo F. Urbano, Auburn Hills, MI (US); David Hinojosa Blandon, Mexico City (MX); Arturo Becerril Franco, Mexico City (MX); Kevin Thompson, Auburn Hills, MI (US)

(21) Appl. No.: 19/191,368

(22) Filed: Apr. 28, 2025

(51) Int. Cl. B66C 1/10

(52) U.S. Cl. CPC B66C 1/107

(57) ABSTRACT

A lift bracket assembly for lifting a hybrid electric powertrain into a vehicle is provided. The hybrid electric powertrain includes an internal combustion engine and a generator. The lift bracket assembly includes a front lift bracket and a rear lift bracket. The front lift bracket includes: an elongated central body portion having at least one central body passage extending therethrough; a first end portion including a mounting ear having a first end passage extending therethrough; and a second end portion including a mounting arm having an attachment passage extending therethrough. The lift bracket is configured to be coupled to an engine block of the internal combustion engine such that the second end portion extends upright above the engine block and away from a mechanical fan of the internal combustion engine. The front lift bracket and rear lift bracket are configured to be engaged by a lift assist tool.

### FIELD

The present application relates generally to hybrid electric vehicles and, more particularly, to a bracket assembly used for lifting and placing an electrified powertrain into the frame of the hybrid electric vehicle.

### BACKGROUND

An electrified vehicle (e.g., hybrid electric, plug-in hybrid electric, range-extended electric, etc.) generally includes a conventional internal combustion engine and at least one electric motor. Plug-in hybrid vehicles include a motor generator that serves as an electric motor for propulsion and as a generator for recharging the battery. The motor generator converts electric energy from the battery into mechanical energy to drive the drive wheels. Moreover, the motor generator converts mechanical energy from braking and other sources back into electrical energy that is used to recharge the battery.

The powerplant of a plug-in hybrid includes the internal combustion engine and a generator coupled together as a single unit. Conventional lift assist tools used to maneuver a powerplant consisting of solely an internal combustion engine and a transmission engage a front bracket permanently coupled to the engine block and a rear foot that engages the transmission. Because the generator in a plug-in hybrid is smaller than the transmission in a conventional internal combustion engine powerplant, a foot at the rear of the engine cannot be used to balance the weight of the powertrain. Furthermore, a mechanical fan that forms part of the internal combustion engine presents additional obstacles in accessing the front of the plug-in hybrid engine for lifting during assembly. Adding a permanent bracket to the plug-in hybrid powertrain for assembly purposes can accomplish assembly, it is undesirable to accommodate the extra mass of the permanent bracket through the life of the vehicle. Accordingly, while such assembly procedures for plug-in hybrid powertrains work well for their intended purpose, there is a desire for improvement in the relevant art.

### SUMMARY

In accordance with one example aspect of the invention, a lift bracket assembly for lifting a hybrid electric powertrain into a vehicle is provided. The hybrid electric powertrain includes an internal combustion engine and a generator. The lift bracket assembly includes a front lift bracket and a rear lift bracket. The front lift bracket includes: an elongated central body portion having at least one central body passage extending therethrough; a first end portion including a mounting ear having a first end passage extending therethrough; and a second end portion including a mounting arm having an attachment passage extending therethrough, wherein the lift bracket is configured to be coupled to an engine block of the internal combustion engine such that the second end portion extends upright above the engine block and away from a mechanical fan of the internal combustion engine. The rear lift bracket is configured to be coupled to the generator. The front lift bracket and rear lift bracket are configured to be engaged by a lift assist tool to move the hybrid electric powertrain relative to a vehicle frame.

In addition to the foregoing, the elongated central body portion has a first central body side and a second central body side that are planar, offset and parallel, wherein the at least one central body passage that extends along a central body passage axis that is perpendicular to the first and second central body sides.

In additional features the first end portion has a first end portion first side and a first end portion second side that are planar, offset and parallel, wherein the first end passage is defined along a first end passage axis that is perpendicular to the first and second sides of the first end portion.

In other implementations, the central body passage axis and the first end passage axis are perpendicular.

In other examples, the lift bracket assembly further includes: a first fastener that extends through the central body passage and threadably mates to a first mounting bore defined in the engine block; and a second fastener that extends through the first end passage and threadably mates to the second mounting bore defined in the engine block.

In additional implementations, the second end portion is configured in a transverse direction relative to the central body portion.

In addition to the foregoing, the front lift bracket is configured to be engaged by a chain extending from the lift assist tool to move the hybrid electric powertrain relative to a vehicle frame.

In addition to the foregoing, the rear lift bracket is configured to be engaged by a fork extending from the lift assist tool to move the hybrid electric powertrain relative to a vehicle frame.

In accordance with another example aspect of the invention, a method of using a lift bracket assembly to lift a hybrid electric powertrain into a vehicle is provided. The hybrid electric powertrain includes an internal combustion engine and a generator. The lift bracket assembly includes (i) a front lift bracket and (ii) a rear lift bracket. The front lift bracket has: an elongated central body portion having at least one central body passage extending therethrough; a first end portion including a mounting ear having a first end passage extending therethrough; and a second end portion including a mounting arm having an attachment passage extending therethrough. The lift bracket is configured to be coupled to an engine block of the internal combustion engine. The method comprises: advancing a first fastener through the at least one central body passage and into a first mounting bore defined in the engine block; advancing a second fastener through the first end passage and into a second mounting bore defined in the engine block such that the second end portion extends upright above the engine block and away from a mechanical fan of the internal combustion engine; engaging, with a lift assist tool, the first lift bracket at the mounting arm of the second end portion at the attachment passage; engaging, with the lift assist tool, the second lift bracket; lifting, with the assist tool, the hybrid electric powertrain relative to a vehicle frame; and decoupling the first lift bracket from the engine block.

In additional features, engaging, with the lift assist tool, the first lift bracket further comprises: coupling a chain extending from the lift assist tool to the attachment passage.

In other features, engaging, with the lift assist tool, the second lift bracket further comprises: engaging a fork extending from the lift assist tool with the second lift bracket.

In additional examples, advancing the first fastener comprises: advancing the first fastener along a central body passage axis defined along the central body passage.

In further examples, advancing the second fastener comprises: advancing the second fastener along a first end passage axis defined along the first end passage, wherein the first end passage axis and the central body passage axis are perpendicular.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a first perspective view of a lift bracket for a plug-in hybrid electric vehicle powertrain constructed in accordance with the principles of the present application;

FIG. 2 is a second perspective view of the lift bracket for a plug-in hybrid electric vehicle powertrain of FIG. 1 constructed in accordance with the principles of the present application;

FIG. 3 is a front perspective view of the lift bracket coupled to the plug-in hybrid electric vehicle powertrain, in accordance with the principles of the present application;

FIG. 4 is a detail perspective view of the lift bracket coupled to the plug-in hybrid electric vehicle powertrain, in accordance with the principles of the present application; and

FIG. 5 is a front perspective view of an exemplary lift assist tool having a chain attached to the front bracket and an engagement fork engaged to a rear bracket extending from the plug-in hybrid electric vehicle powertrain in accordance with the principles of the present application.

### DETAILED DESCRIPTION

As noted above, the powerplant of a plug-in hybrid includes the internal combustion engine and a generator coupled together as a single unit. Conventional lift assist tools used to maneuver a traditional powerplant consisting of solely an internal combustion engine and a transmission engage a front bracket permanently coupled to the engine block and a rear foot that engages the transmission. Because the generator in a plug-in hybrid is smaller than the transmission in a conventional internal combustion engine powerplant, a foot at the rear of the engine cannot be used to balance the weight of the powertrain. Furthermore, a mechanical fan that forms part of the internal combustion engine presents additional obstacles in accessing the front of the plug-in hybrid engine for lifting during assembly. Adding a permanent bracket to the plug-in hybrid powertrain for assembly purposes is undesirable.

The present disclosure provides a lift bracket that is coupled to a front end of the engine block. The lift bracket is fixed at two attachment points on the engine block and has an upper extending portion that includes a coupling bore. A coupling device, such as a chain, is configured to securely connect at the coupling bore. The coupling device is attached at an opposite end relative to a bracket extending from a lift assist tool. A fork extending from the bracket engages a rear bridal bracket extending from the motor generator. Once the lift assist tool places the engine generator assembly relative to the vehicle frame, the bracket is removed from the engine block.

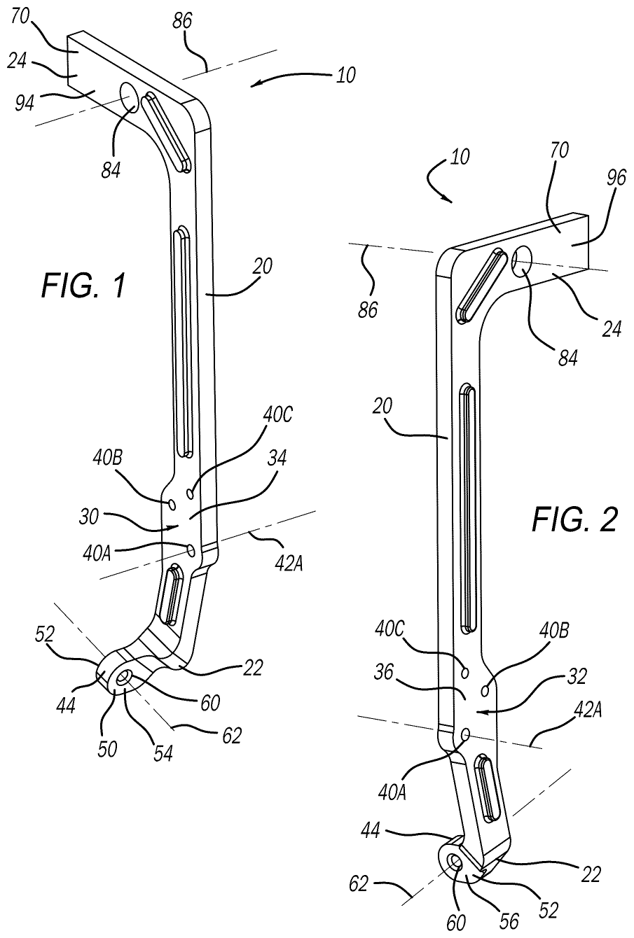

With initial reference to FIGS. 1 and 2, a front lift bracket constructed in accordance to one example of the present disclosure is shown and generally identified at reference numeral 10. The front lift bracket 10 generally includes an elongated central body portion 20, a first end portion 22, and a second end portion 24. The elongated central body portion 20 has a first side 30, a second side 32, and a series of central body passages 40A, 40B, 40C extending therethrough. A central body passage axis 42A is defined along the passage 40A. In examples, the first and second sides 30 and 32 can be planar and offset, parallel surfaces 34 and 36. In additional examples, the central body passage axis 42A can be perpendicular to the parallel surfaces 34 and 36.

The first end portion 22 includes a mounting ear 44. The mounting ear 44 has a first side 50, a second side 52, and a first end passage 60 extending therethrough. A first end passage axis 62 is defined along the first end passage 60. In examples, the first and second sides 50 and 52 can be planar and offset, parallel surfaces 54 and 56. In additional examples, the first end passage axis 62 can be perpendicular to the parallel surfaces 54 and 56. In some arrangements, the central body passage axis 42A and the first end passage axis 62 are perpendicular, or substantially perpendicular relative to each other. By arranging the axes in a perpendicular fashion, the coupling of the lift bracket 10 to the hybrid powertrain is more robust and can achieve distinct lifting axes that spread forces more evenly onto the engine block.

The second end portion 24 includes a mounting arm 70. The second end portion 24 is configured in a transverse direction relative to the central body portion 20. The mounting arm 40 has a first side 80, a second side 82 and an attachment passage 84 extending therethrough. An attachment passage axis 86 is defined along the attachment passage 84. In examples, the first and second sides 80 and 82 can be planar and offset, parallel surfaces 94 and 96. In further examples, the attachment passage axis 86 can be perpendicular to the parallel surfaces 94 and 96. In some arrangements, the attachment passage axis 86 is parallel and offset relative to the central body passage axis 42A.

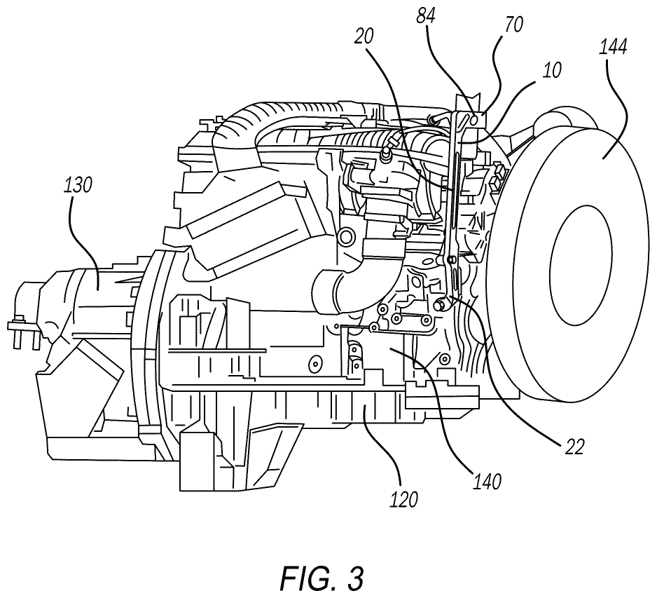

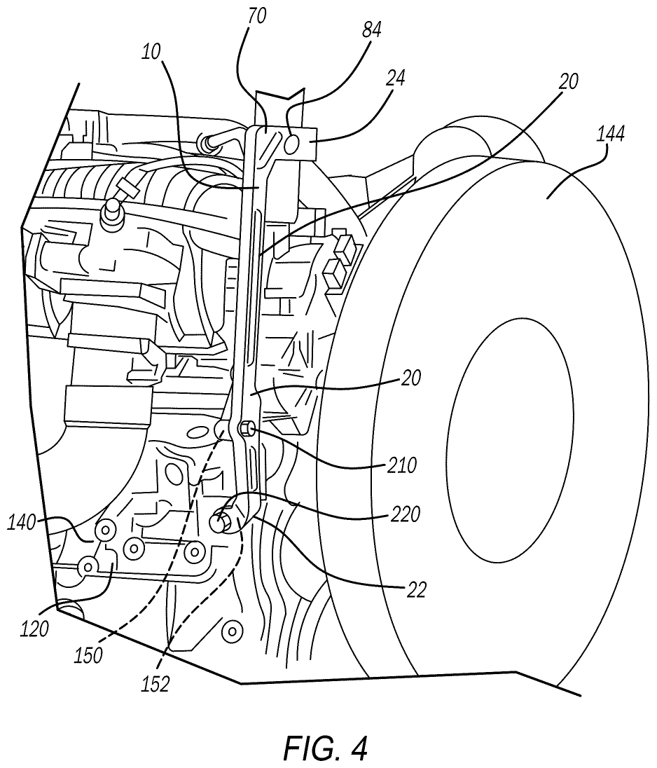

With continued reference to FIGS. 1 and 2, and additional reference to FIGS. 3-5, the front lift bracket 10 is shown attached to an engine generator assembly or powertrain 110. The powertrain 110 generally includes an internal combustion engine 120 and a generator 130. The internal combustion engine 120 includes an engine block 140 and a mechanical fan 144. It will be appreciated that the internal combustion engine 120 and/or the generator 130 shown is merely exemplary and may comprise many iterations. In this regard, the front lift bracket 10 can be used with other hybrid powertrain configurations.

The engine block 140 includes a first mounting bore 150 and a second mounting bore 152 defined thereon. The first and second mounting bores 150 and 152 can comprise threaded bores formed into the engine block 140. In the example shown, the first and second mounting bores 150 and 152 can be defined on non-parallel axes complementary to the passage axis 42A and the passage axis 62.

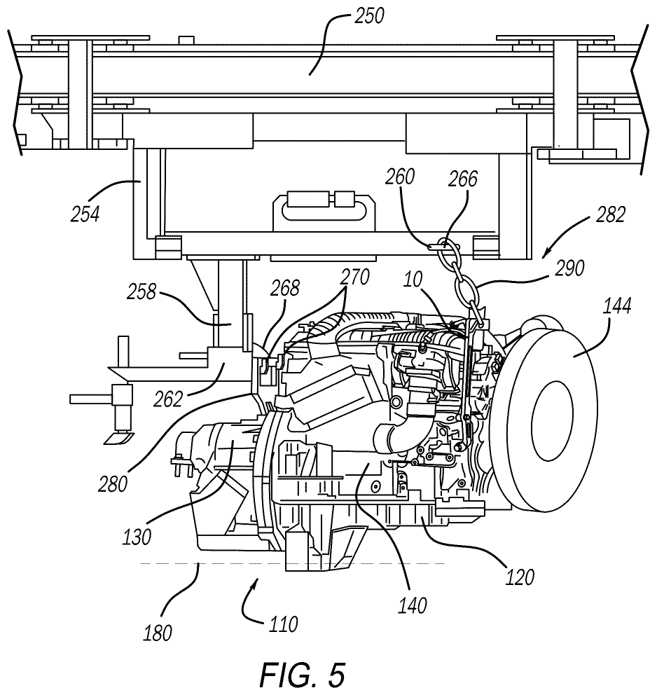

An exemplary assembly sequence of lifting the powertrain 110 relative to a vehicle frame 180 (FIG. 5) using the front lift bracket 10 will now be described. At the outset, the front lift bracket 10 is attached to the engine block 140 of the powertrain 110. Again, in advantages of the instant front lift bracket 10, the front lift bracket 10 is only coupled to the engine block 140 for assembly of the powertrain 110 relative to the vehicle frame 180. Once the powertrain 110 has been located onto and attached relative to the vehicle frame 180, the front lift bracket 10 is removed from the engine block 140 and can be reused for lifting another powertrain 110. In this regard, the front lift bracket 10 will not stay with the powertrain 110 during the life of the vehicle adding unnecessary mass to the vehicle.

In examples, the front lift bracket 10 is attached to the engine block by threadably advancing a first fastener 210 through the central body passage 40A of the bracket 70 and into the first engine mounting bore 150. Next, a second fastener 220 is threadably advanced through the first end passage 60 at the mounting ear 44 of the bracket 10 and into the second engine mounting bore 152. It is appreciated that the order may be reversed with the second fastener 220 being located first. Alternatively, both of the first and second fasteners 210, 220 can be driven concurrently into the mounting bores 150 and 152 of the engine block 140.

Once the front lift bracket 10 is suitably attached to the engine 120 of the powertrain 110, the powertrain 110 can be connected to a lift assist tool 250. The lift assist tool 250 can generally include a lift frame 254 having a front attachment member 260 and a rear attachment member 262. In the example shown, the front attachment member 260 includes an attachment hoop 266 and the rear attachment member 262 includes a fork 268. The fork 268 can include one or more fingers 270. Other configurations are contemplated.

A rear bracket 280 is connected to and extends from the generator 130. The front lift bracket 10 and the rear bracket 280 can collectively define a lift bracket assembly 282 that are used to collectively engage and lift the powertrain 110. A chain 290 is connected between the attachment hoop 266 of the front attachment member 260 and the coupling bore 84 of the lift bracket 70. Fingers 270 of the fork 268 on the rear attachment member 262 are located into a position of engagement with the rear bracket 280. The lift assist tool 250 is caused to lift and negotiate the powertrain 110 onto the vehicle frame 180. Once the powertrain 110 is suitably located relative to the vehicle frame 180, the chain 290 can be removed relative to the bracket 10 and/or the bracket 10 can be removed from the engine block 140. The fingers 270 are further removed from the bracket 280.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A lift bracket assembly for lifting a hybrid electric powertrain into a vehicle, the hybrid electric powertrain including an internal combustion engine and a generator, the lift bracket assembly comprising:
a front lift bracket having:
an elongated central body portion having at least one central body passage extending therethrough;
a first end portion including a mounting ear having a first end passage extending therethrough;
a second end portion including a mounting arm having an attachment passage extending therethrough, wherein the lift bracket is configured to be coupled to an engine block of the internal combustion engine such that the second end portion extends upright above the engine block and away from a mechanical fan of the internal combustion engine; and
a rear lift bracket configured to be coupled to the generator;
wherein the front lift bracket and rear lift bracket are configured to be engaged by a lift assist tool to move the hybrid electric powertrain relative to a vehicle frame.

2. The lift bracket assembly of claim 1, wherein the elongated central body portion has a first central body side and a second central body side that are planar, offset and parallel, wherein the at least one central body passage that extends along a central body passage axis that is perpendicular to the first and second central body sides.

3. The lift bracket assembly of claim 2, wherein the first end portion has a first end portion first side and a first end portion second side that are planar, offset and parallel, wherein the first end passage is defined along a first end passage axis that is perpendicular to the first and second sides of the first end portion.

4. The lift bracket assembly of claim 3, wherein the central body passage axis and the first end passage axis are perpendicular.

5. The lift bracket assembly of claim 4, further comprising:
a first fastener that extends through the central body passage and threadably mates to a first mounting bore defined in the engine block; and
a second fastener that extends through the first end passage and threadably mates to the second mounting bore defined in the engine block.

6. The lift bracket assembly of claim 1, wherein the second end portion is configured in a transverse direction relative to the central body portion.

7. The lift bracket assembly of claim 1, wherein the front lift bracket is configured to be engaged by a chain extending from the lift assist tool to move the hybrid electric powertrain relative to a vehicle frame.

8. The lift bracket assembly of claim 7, wherein the rear lift bracket is configured to be engaged by a fork extending from the lift assist tool to move the hybrid electric powertrain relative to a vehicle frame.

9. A method of using a lift bracket assembly to lift a hybrid electric powertrain into a vehicle, the hybrid electric powertrain including an internal combustion engine and a generator, the lift bracket assembly including (i) a front lift bracket and (ii) a rear lift bracket, the front lift bracket having: an elongated central body portion having at least one central body passage extending therethrough; a first end portion including a mounting ear having a first end passage extending therethrough; and a second end portion including a mounting arm having an attachment passage extending therethrough, wherein the lift bracket is configured to be coupled to an engine block of the internal combustion engine, the method comprising:
advancing a first fastener through the at least one central body passage and into a first mounting bore defined in the engine block;
advancing a second fastener through the first end passage and into a second mounting bore defined in the engine block such that the second end portion extends upright above the engine block and away from a mechanical fan of the internal combustion engine;
engaging, with a lift assist tool, the first lift bracket at the mounting arm of the second end portion at the attachment passage;
engaging, with the lift assist tool, the second lift bracket;
lifting, with the assist tool, the hybrid electric powertrain relative to a vehicle frame; and
decoupling the first lift bracket from the engine block.

10. The method of claim 9, wherein engaging, with the lift assist tool, the first lift bracket comprises:
coupling a chain extending from the lift assist tool to the attachment passage.

11. The method of claim 10, wherein engaging, with the lift assist tool, the second lift bracket comprises:
engaging a fork extending from the lift assist tool with the second lift bracket.

12. The method of claim 9, wherein advancing the first fastener comprises:
advancing the first fastener along a central body passage axis defined along the central body passage.

13. The method of claim 12, wherein advancing the second fastener comprises:
advancing the second fastener along a first end passage axis defined along the first end passage, wherein the first end passage axis and the central body passage axis are perpendicular.
